(19) United States
(12) Patent Application Publication
(10) Pub. No.: US 2022/0349700 A1
(43) Pub. Date: Nov. 3, 2022

(54) MEASURING APPARATUS FOR INTERFEROMETRIC SHAPE MEASUREMENT

(71) Applicant: CARL ZEISS SMT GMBH, Oberkochen (DE)

(72) Inventors: Jochen HETZLER, Aalen (DE); Stefan SCHULTE, Stoedlen (DE); Matthias DREHER, Oberkochen (DE)

(21) Appl. No.: 17/869,333

(22) Filed: Jul. 20, 2022

Related U.S. Application Data
(63) Continuation of application No. PCT/EP2021/050975, filed on Jan. 19, 2021.

(30) Foreign Application Priority Data
Jan. 21, 2020 (DE) 102020200628.8

(51) Int. Cl. G01B 9/02; G01B 9/02056; G01B 9/02055; G01B 11/24; G01M 11/00

(52) U.S. Cl. CPC G01B 9/02039; G01B 9/02057; G01B 9/02072; G01B 11/2441; G01M 11/005; G01B 2290/30

(57) ABSTRACT

A measurement apparatus for interferometric shape measurement of a test object surface. A test optical unit produces from measurement radiation a test wave for irradiating the surface. A reference element with an optically effective surface interacts with a reference wave also produced from the measurement radiation. An interferogram is produced by superimposing the test wave after interaction with the test object's surface. A holding device holds the reference element and moves the reference element relative to the reference wave in at least two rigid body degrees of freedom so that a peripheral point of the reference element's optically effective surface shifts by at least 0.1% of a diameter of the optically effective surface. The at least two degrees of freedom include a translational degree, directed transversely to a propagation direction of the reference wave and a rotational degree, whose rotational axis aligns substantially parallel to the reference wave's propagation direction.

### CROSS REFERENCE TO RELATED APPLICATIONS

This is a Continuation of International Application PCT/EP2021/050975, which has an international filing date of Jan. 19, 2021, and the disclosure of which is incorporated in its entirety into the present Continuation by reference. In addition, the present Continuation claims the benefit of and priority to German patent application 10 2020 200 628.8, filed Jan. 21, 2020. The entire content and disclosure of this German patent application is also incorporated by reference into the present Continuation.

### FIELD OF THE INVENTION

The invention relates to a measurement apparatus for interferometric shape measurement of a surface of a test object, to a method for calibrating such a measurement apparatus and to a method for interferometric shape measurement of the aforementioned surface. For example, a microlithographic optical element is measured as the test object. As a result of the need for ever smaller structures, ever higher demands are placed on the optical properties of optical elements used in microlithography. The optical surface shape of these optical elements must therefore be determined with the highest possible accuracy.

### BACKGROUND

Interferometric measurement apparatuses and methods in which a diffractive optical element produces a test wave and a reference wave from an input wave are known for the highly accurate interferometric measurement of optical surfaces down to the subnanometer range. The diffractive optical element allows the wavefront of the test wave to be adapted to a target surface of the test object in such a way that said wavefront is substantially normally incident at every location on the target shape and reflected back onto itself from the target surface. Deviations from the target shape can then be determined with the aid of the interferogram formed by superposing the reflected test wave on the reference wave.

US 2015/0198438A1 describes such an interferometric measurement apparatus with a Fizeau element as a reference element for producing the reference wave. US2018/0106591A1 describes an alternative embodiment of the measurement apparatus mentioned in the introductory part, in which a complex encoded computer-generated hologram (CGH) is used as a diffractive optical element. The CGH produces from an input wave a test wave, directed at the surface to be measured, with a wavefront that is at least partially adapted to a target shape of the optical surface and a plane reference wave running in its own reference arm. The reference wave is reflected back to the CGH by a reflective optical reference element.

Furthermore, the CGH produces from the input wave a calibration wave with a plane wavefront and a calibration wave with a spherical wavefront. The calibration waves are reflected back on themselves by a plane and a spherical calibration mirror. The CGH is calibrated with the aid of the calibration waves. In this way, for example, local changes in position, such as CGH deformations or CGH distortions, can be corrected and thus measurement errors reduced.

To ensure highly accurate measurements, shape errors of the reference element are also measured by an interferometer in order to computationally remove them from the measurement result for the shape of the test object. Conventionally, this requires an additional calibration optical unit and/or an additional calibration plate. In the case of the measurement apparatus mentioned above with a Fizeau element as a reference element, an additional calibration plate can be arranged instead of the test object in the beam path of the test wave and the calibration plate can be shifted or tilted by a mechanism for calibrating the reference element.

To this end, however, the test object must first be removed, which greatly increases the time required for the measurement method. Even in the event that the additional calibration optical unit or additional calibration plate is arranged at a different location in the beam path of the test or reference wave, as is conceivable for the abovementioned embodiment with its own reference arm, the removal of the test object or at least shadowing of the test object is necessary.

Since the calibration of the reference element and the measurement of the test object take place at significantly different time points due to the necessary change in the construction of the measurement apparatus, the calibration result may no longer accurately reflect the surface shape of the reference element at the time the test object was measured, for example due to thermal drifts, which in turn leads to a reduced measurement accuracy.

### SUMMARY

It is an object of the invention to provide a measurement apparatus and a calibration method with which the aforementioned problems are solved and, in particular, an interferometric shape measurement with a high measurement accuracy and reduced time requirement is ensured.

The aforementioned object is achieved according to one formulation of the invention, with a measurement apparatus for interferometric shape measurement of a surface of a test object with a test optical unit, which is configured to produce from measurement radiation a test wave for irradiating the surface of the test object, a reference element with an optically effective surface for interaction with a reference wave that has likewise been produced from the measurement radiation and serves for producing an interferogram by superimposition with the test wave after the test wave has interacted with the surface of the test object, and a holding device for holding the reference element, which is configured to move the reference element in relation to the reference wave in at least two rigid body degrees of freedom such that a peripheral point of the optically effective surface of the reference element is shifted by at least 0.1%, in particular at least 0.5% or at least 1% of a diameter of the optically effective surface. The at least two rigid body degrees of freedom comprise a translational degree of freedom, which is directed transversely to a propagation direction of the reference wave emitted by the reference element, and a rotational degree of freedom, whose axis of rotation is aligned substantially parallel to the propagation direction of the reference wave emitted by the reference element.

The holding device is configured to move the reference element in relation to the radiated reference wave, and in particular also in relation to the test optical unit. A rigid body degree of freedom is understood to mean a translational degree of freedom or a rotational degree of freedom.

The holding device configured to move the reference element in at least two rigid body degrees of freedom allows the reference element to be calibrated without having to change the construction of the measurement apparatus by installing its own calibration optical unit or calibration plate and/or removing the test object from its measurement position in the beam path of the test wave or shadowing the test object. In other words, the holding device according to the invention allows an “in-situ calibration” of the reference element, i.e., a calibration of the reference element without the need to change the configuration of the measurement apparatus, by moving the reference element to different calibration positions and recording a corresponding interferogram produced by superposing the reference wave after it has interacted with the reference element and the test wave after it has interacted with the test object. The evaluation of the interferograms produced at the different calibration positions of the reference element then makes it possible to computationally remove surface errors of the reference element from the measurement result of the surface shape of the test object. The calibration of the reference element “in situ” or in the installation position of the test object reduces the time required for the interferometric measurement method of the test object including the calibration of the reference element and additionally increases an improved measurement accuracy in the shape measurement due to the quick succession between the calibration of the reference element and the shape measurement of the test object that is thus enabled.

The substantially parallel alignment of the axis of rotation of the rotational degree of freedom to the propagation direction of the reference wave emitted by the reference element is to be understood to mean an alignment which deviates from the exactly parallel alignment by a maximum of +/−10°.

According to one embodiment, the measurement apparatus comprises an evaluation device for ascertaining a calibration deviation of the reference element on the basis of a deviation of an optical effect of the reference element on the wavefront of the reference wave from an intended effect by evaluating recorded interferograms.

Since the test object does not have to be removed in order to calibrate the reference element owing to the holding device according to the invention, the time interval between the calibration and the measurement of the test object can be reduced, which means that the calibration result is more up-to-date when the shape of the test object is measured and the measurement accuracy is therefore improved. In addition, the time required for the interferometric measurement is reduced.

Since the rigid body degrees of freedom, with respect to which the reference element is movable, comprise the translational degree of freedom described and also the rotational degree of freedom described, an absolute calibration of the reference element becomes possible with a rotation-shift calibration.

According to one embodiment of the invention, the holding device is configured to move the reference element in at least two rigid body degrees of freedom such that in each case the peripheral point of the optically effective surface of the reference element is shifted by at least 0.1%, in particular at least 0.5% or at least 1% of a diameter of the optically effective surface.

According to one embodiment, the rigid body degrees of freedom, with respect to which the reference element is movable, comprise two translational degrees of freedom. This makes an absolute calibration of the reference element through a shift-shift calibration possible. According to this embodiment, the holding device is configured to move the reference element relative to the reference wave in at least three degrees of freedom, in particular in at least four degrees of freedom or in at least five degrees of freedom, such that the peripheral point of the optically effective surface of the reference element is shifted by at least 0.1% of a diameter of the optically effective surface.

In particular, both translational degrees of freedom are aligned transversely to the propagation direction of the reference wave emitted by the reference element.

According to a further embodiment, the at least two rigid body degrees of freedom comprise at least one rotational degree of freedom, whose axis of rotation is aligned transversely, in particular perpendicularly, to a propagation direction of the reference wave emitted by the reference element. According to this embodiment, the holding device is configured to move the reference element relative to the reference wave in at least three degrees of freedom, in particular in at least four degrees of freedom or in at least five degrees of freedom, such that the peripheral point of the optically effective surface of the reference element is shifted by at least 0.1% of a diameter of the optically effective surface. In particular, two rotational degrees of freedom are provided, which are transverse, in particular perpendicular, to one another. In one embodiment, the reference element preferably has a spherical shape.

According to a further embodiment, the at least two rigid body degrees of freedom comprise at least two rotational degrees of freedom. This can, for example, be a combination of one rotational degree of freedom with an axis of rotation aligned substantially parallel to the propagation direction of the reference wave emitted by the reference element with one rotational degree of freedom with an axis of rotation aligned transversely to said propagation direction, or two degrees of rotational freedom, each with axes of rotation aligned transversely to the propagation direction mentioned. According to this embodiment, the holding device is configured to move the reference element relative to the reference wave in at least three degrees of freedom, in particular in at least four degrees of freedom or in at least five degrees of freedom, such that the peripheral point of the optically effective surface of the reference element is shifted by at least 0.1% of a diameter of the optically effective surface.

According to a further embodiment, the holding device comprises a plurality of actuators for moving the reference element in the at least two rigid body degrees of freedom. A linear drive, for example, can be used to move along a translational degree of freedom. As an alternative to an actuator, one or more manual adjustment modules can be used.

According to a further embodiment, the measurement apparatus comprises a Fizeau interferometer with a Fizeau element, wherein the reference element is the Fizeau element.

According to an alternative embodiment, the test optical unit comprises a diffractive optical element for splitting the incoming measurement radiation into the test wave and the reference wave, and the reference element is arranged in the beam path of the reference wave. According to an embodiment variant, the reference element is configured as a mirror. In other words, the reference element is configured as a reference mirror of an interferometer with a reference arm. The reference wave travels in the reference arm. The reference arm has a different direction than the test arm, in which the test wave travels. Alternatively, the reference element can also be configured as a lens element, which is part of a reflection module made up of the lens element and an associated mirror, for example.

According to a further embodiment, the measurement apparatus is configured for interferometric shape measurement of a surface of a microlithographic optical element. In particular, the optical element is an optical element, such as a lens element or a mirror, of a microlithographic projection exposure apparatus, in particular a projection lens of such a projection exposure apparatus. According to one embodiment, the optical element is configured for extreme ultraviolet (EUV) microlithography.

According to a further formulation, the aforementioned object is achieved, with a method for calibrating a measurement apparatus for interferometric shape measurement of a surface of a test object, which is configured to produce an interferogram by superimposition of a test wave after the test wave has interacted with the surface of the test object with a reference wave after the reference wave has interacted with a reference element. The method comprises: arranging the reference element at different calibration positions in relation to the reference wave, which differ by a movement in at least two rigid body degrees of freedom, recording the interferograms produced at the different calibration positions, and ascertaining a calibration deviation on the basis of a deviation of an optical effect of the reference element on the wavefront of the reference wave from an intended effect by evaluating the recorded interferograms. The at least two rigid body degrees of freedom comprise a translational degree of freedom, which is directed transversely to a propagation direction of the reference wave emitted by the reference element, and a rotational degree of freedom, whose axis of rotation is aligned substantially parallel to the propagation direction of the reference wave emitted by the reference element.

According to a further embodiment of the calibration method, the test object is configured as a microlithographic optical element. In particular, the optical element is an optical element, such as a lens element or a mirror, of a microlithographic projection exposure apparatus, in particular a projection lens of such a projection exposure apparatus. According to one embodiment, the optical element is configured for EUV microlithography.

The features specified with regard to the aforementioned embodiments, exemplary embodiments and embodiment variants, etc. of the measurement apparatus according to the invention can correspondingly be applied to the calibration method according to the invention. These and other features of the embodiments according to the invention will be explained in the description of the figures and in the claims. The individual features can be implemented, either separately or in combination, as embodiments of the invention. Furthermore, they can describe advantageous embodiments which are independently protectable and protection for which is claimed if appropriate only during or after pendency of the application.

Furthermore, according to a further formulation, the invention provides a method for interferometric shape measurement of a surface of a test object. This method comprises: determining a calibration deviation of a measurement apparatus by the method according to one of the embodiments or by embodiment variants described above. The method also comprises recording a measurement interferogram with the measurement apparatus by superimposing the test wave after it has interacted with the surface of the test object with the reference wave after it has interacted with the reference element in a measurement position, and determining the surface shape of the test object by evaluating the measurement interferogram taking into account the calibration deviation.

The measurement position of the reference element can here match one of the calibration positions, so that one of the calibration interferograms can also be used as the measurement interferogram.

### BRIEF DESCRIPTION OF THE DRAWINGS

The above and further advantageous features of the invention will be illustrated in the following detailed description of exemplary embodiments according to the invention with reference to the accompanying schematic drawings. In the drawings:

FIG. 1 shows a first embodiment of a measurement apparatus for interferometric shape measurement of a surface of a test object having a holding device according to the invention in a first embodiment for holding a reference element in the form of a mirror,

FIG. 2 shows a further embodiment of a measurement apparatus for interferometric shape measurement of a surface of a test object having the holding device according to the invention in the first embodiment for holding a reference element in the form of a Fizeau element,

FIG. 3 shows the embodiment of the holding device according to FIG. 1 or 2 in a sectional view,

FIG. 4 shows the holding device in a further embodiment, and

FIG. 5 shows a further embodiment of a measurement apparatus for interferometric shape measurement of a surface of a test object having a holding device according to the invention in a further embodiment.

### DETAILED DESCRIPTION

In the exemplary embodiments or embodiments or embodiment variants described below, elements which are functionally or structurally similar to one another are provided with the same or similar reference signs as far as possible. Therefore, for understanding the features of the individual elements of a specific exemplary embodiment, reference should be made to the description of other exemplary embodiments or the general description of the invention.

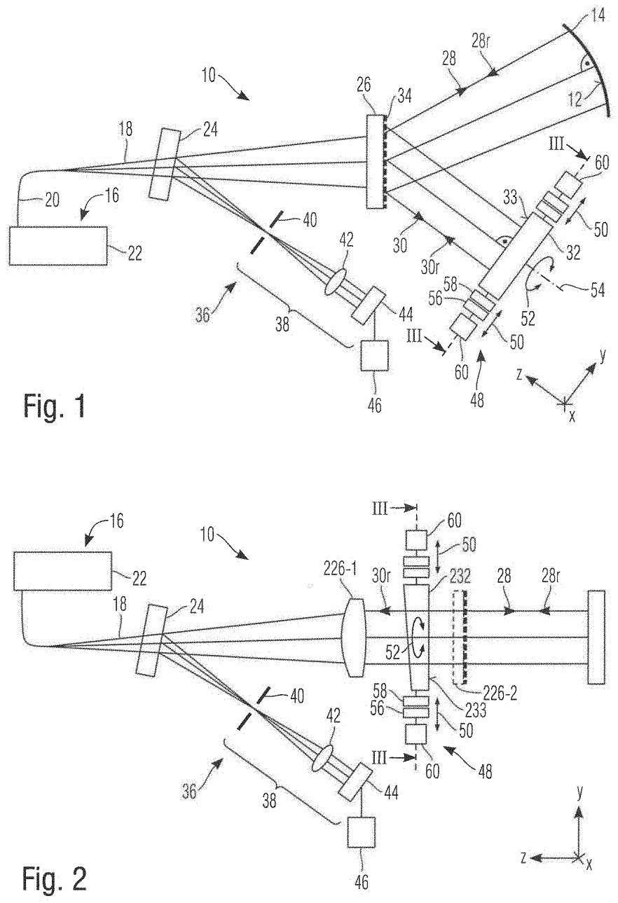

In order to facilitate the description, a Cartesian xyz-coordinate system is indicated in the drawing, from which system the respective positional relationships of the components illustrated in the figures is evident. In FIG. 1, the x-direction runs perpendicular to the plane of the drawing into it, the y-direction runs diagonally to the top right, and the z-direction runs diagonally to the top left.

FIG. 1 shows an exemplary embodiment of a measurement apparatus 10 for interferometric shape measurement of an optical surface 12 of a test object 14. The measurement apparatus 10 can be used, in particular, to determine a deviation of the actual shape of the surface 12 from a target shape. The test object 14 provided can be, for example, a mirror of a projection lens for extreme ultraviolet (EUV) microlithography having a non-spherical surface for reflecting EUV radiation at a wavelength of less than 100 nm, in particular a wavelength of approximately 13.5 nm or approximately 6.8 nm. The non-spherical surface of the mirror can have, for example, a free-form surface with a deviation of more than 5 μm from each rotation-symmetric asphere and a deviation of at least 1 mm from each sphere.

The measurement apparatus 10 contains a radiation source 16 for providing a sufficiently coherent measurement radiation 18 as an input wave. In this exemplary embodiment, the radiation source 16 comprises a waveguide 20 having an exit surface from which the input wave originates. The waveguide 20 is connected to an illustrated radiation-generating module 22, e.g., in the form of a laser. By way of example, provision to this end can be made of a helium-neon laser with a wavelength of about 633 nm. However, the measurement radiation 18 can also have a different wavelength in the visible or non-visible wavelength range of electromagnetic radiation. The radiation source 16 with the waveguide 20 merely represents an example of a radiation source 16 that can be used for the measurement apparatus. In alternative embodiments, rather than the waveguide 20, an optical arrangement with lens elements, mirror elements or the like can be provided for providing a suitable input wave from the measurement radiation 18.

The measurement radiation 18 initially passes through a beam splitter 24 and is subsequently incident on a diffractive optical element 26. The diffractive optical element 26 forms a test optical unit, which serves to produce a test wave 28 for irradiating the surface 12 of the test object 14. In addition to the test wave 28, the diffractive optical element 26 of the test optical unit produces from the incident measurement radiation 18 a reference wave 30, which travels in its own reference arm.

Furthermore, the measurement arrangement 10 comprises a reference element 32, designed as a reflective optical element, with an optically effective surface in the form of a reflection surface 33 for reflecting the reference wave 30 into a returning reference wave 30r. According to an alternative embodiment, the reference element can also be configured as a lens element which produces the returning reference wave 30r in cooperation with a mirror. In the case of a lens element, the optically effective surface is understood to mean a lens element surface interacting with the reference wave 30.

The diffractive optical element 26 is designed in the form of a complex encoded CGH and contains diffractive structures 34 which, according to the embodiment illustrated in FIG. 1, form two diffractive structure patterns that are arranged mutually superposed in a plane. The diffractive optical element 26 is therefore also referred to as a twice complex encoded computer-generated hologram (CGH). Alternatively, the diffraction structures could also have more than two diffractive structure patterns arranged mutually superposed in a plane, for example five diffractive structure patterns arranged mutually superposed, for additionally producing calibration waves. The test optical unit for producing the test wave 28 can also consist of more than one diffractive optical element, such as of two diffractive optical elements arranged one after the other.

The two diffractive structure patterns of the diffractive optical element 26 according to FIG. 1 can be formed, for example, by a first structure pattern in the form of a bottom grating and a second diffractive structure pattern in the form of a top grating. One of the diffractive structure patterns is configured to produce the test wave 28, which is directed at the test object 14 and has a wavefront that is at least partially adapted to a target shape of the optical surface 12. The test wave 28 is reflected at the optical surface 12 of the test object 14 and returns to the diffractive optical element 26 as a returning test wave 28r. Due to the wavefront that is adapted to the target shape of the optical surface 12, the test wave 28 is substantially normally incident at every location on the optical surface 12 and is reflected back on itself.

The other diffractive structure pattern produces the reference wave 30, which is directed at the reference element 32 and has a plane wavefront. In alternative exemplary embodiments, a simply encoded CGH with a diffractive structure or another optical grating can be used instead of the complex encoded CGH. The test wave 28 can for example be produced in a first order of diffraction, and the reference wave 30 can be produced in the zero or any other order of diffraction at the diffractive structure.

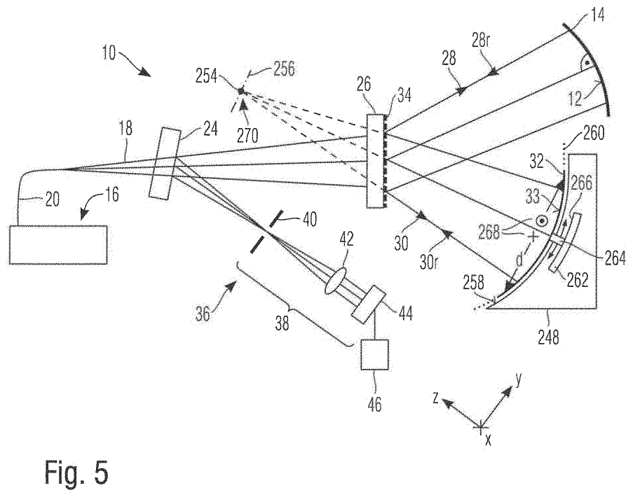

The reference element 32 in the present embodiment is designed in the form of a plane mirror for back-reflection of the reference wave 30 with a plane wavefront. In another embodiment, which is described below with reference to FIG. 5, the reference wave 30 can have a spherical wavefront, and the reference element 32 can be designed as a spherical mirror.

The test wave 28r returning from the surface 12 passes through the diffractive optical element 26 again and is diffracted again in the process. In this case, the returning test wave 28r is transformed back into an approximately spherical wave, wherein the wavefront thereof has corresponding deviations from a spherical wavefront due to deviations of the surface 12 of the test object from the target shape.

The returning reference wave 30r reflected by the reflection surface of the reference element 32 also passes through the diffractive optical element 26 again and is again diffracted in the process. In this case, the returning reference wave 30r is transformed back into an approximately spherical wave. In an alternative embodiment with a collimator in the beam path of the measurement radiation 18 radiated onto the diffractive optical element 26 for generating an input wave with a plane wavefront, the wavefront of the returning reference wave 30r does not need to be adapted by way of the diffractive optical element 26.

The diffractive optical element 26 therefore also serves for superimposing the returning test wave 28r with the returning reference wave 30r. The measurement arrangement 10 furthermore contains a capturing device 36 having the previously mentioned beam splitter 24 for guiding the combination of the returning test wave 28r and the returning reference wave 30r out of the beam path of the measurement radiation 18, and an observation unit 38 for capturing an interferogram produced by superimposing the test wave 28r with the reference wave 30r.

The returning test wave 28r and the returning reference wave 30r are incident on the beam splitter 24 as convergent beams and are reflected thereby in the direction of the observation unit 38. Both convergent beams pass through a stop 40 and an eyepiece 42 of the observation unit 38 and are finally incident on a two-dimensionally resolving detector 44 of the observation unit 38. The detector 44 can be designed, for example, as a CCD sensor and captures an interferogram produced by the interfering waves.

Furthermore, the measurement arrangement 10 comprises an evaluation device 46 for determining the actual shape of the optical surface 12 of the test object 14 from the captured interferogram or interferograms. To this end, the evaluation device has a suitable data processing unit and uses corresponding calculation methods known to a person skilled in the art. Alternatively or additionally, the measurement apparatus 10 can have a data memory or an interface with a network to make possible a determination of the surface shape using the interferogram that is stored or transmitted via the network by way of an external evaluation unit. When determining the surface shape, the evaluation unit takes into account the result of the calibration, described in detail below, of the reference element 32 in the form of a calibration deviation of the reference element 32.

The mentioned calibration of the reference element 32 serves to measure figure errors of the reflection surface 33, i.e., in the present case deviations of the reflection surface 33 from a perfectly planar surface. According to the embodiment according to the invention, this measurement is carried out without removing the test object 14 from its test position shown in FIG. 1. In other words, the calibration measurement is an “in-situ calibration” with regard to the used measurement, in which a plurality of interferograms formed by superimposing the test wave 28r returning from the test object 14 with the returning reference wave 30r are recorded and evaluated.

For the different interferograms, the reference element 32 is arranged at different calibration positions, which differ in at least one rigid body degree of freedom, in particular in two or three rigid body degrees of freedom, due to a movement of the reference element 32 with the holding device 48. By comparing the interferograms measured at the different calibration positions of the reference element 32, deviations of the reflection surface 33 from its target shape, in particular from a perfectly planar surface, can be determined.

In the embodiment shown in FIG. 1, the measurement apparatus 10 has a holding device 48 for holding the reference element 32, which is configured to move the reference element 32 for arrangement in the different calibration positions in a translational degree of freedom and a rotational degree of freedom. This enables a so-called “rotation-shift calibration.”

The translational degree of freedom, which is indicated by double-headed arrows 50 in FIG. 1, is an ability to be shifted in the y-direction and thus transversely to the propagation direction of the reference wave 30r emitted by the reference element 32 in the z-direction. The rotational degree of freedom, which is indicated by a curved double-headed arrow 52 in FIG. 1, has an axis of rotation 54, which is arranged in the z-direction and thus parallel to the propagation direction of the returning reference wave 30r.

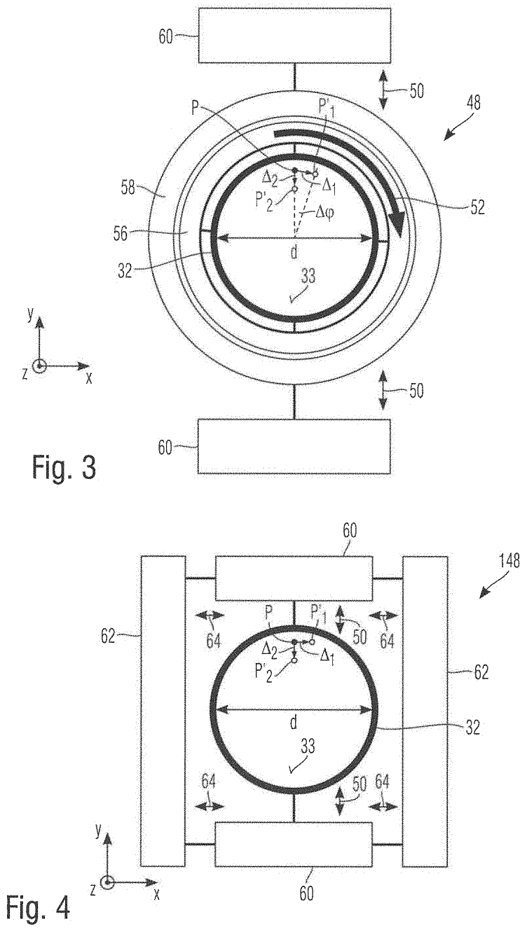

FIG. 3 shows a sectional view through the holding device 48 and the reference element 32 along the line in FIG. 1. As can be seen therefrom, the reference element 32 is attached to an inner holding ring 56 of the holding device 48. The inner holding ring 56 is rotatably supported within an outer holding ring 58. The rotational movement can be effected by a rotary actuator or manually. The outer holding ring 58 is in turn connected from two opposite sides to a y-actuator 60 in the form of a linear drive for shifting the reference element 32 in the y-direction. Alternatively, the outer holding ring 58 can also be shifted in the y-direction by manual adjustment devices.

The rotational degree of freedom mentioned above with respect to the axis of rotation 54 is implemented with the rotational support of the inner holding ring 56. The adjustability of the rotational position of the reference element 32 is at least 2 mrad, preferably at least 10 mrad or even more preferably at least 20 mrad. If the rotational position changes by 2 mrad, a peripheral point P of the reflection surface 33 of the reference element 32 is shifted by at least 0.1% of the diameter d of the reflection surface 33 (see shift by Δ₁—the shifted point P is denoted by P′₁).

The adjustability of the y-position of the reference element 32 by the y-actuators 60 is at least 0.1%, preferably at least 0.5% or even more preferably at least 1% of the diameter d of the reflection surface 33 (see shift of point P by Δ₂— the shifted point P is denoted by P′₂). With an exemplary diameter d of the reflection surface 33, the peripheral point P is shifted by 0.1 mm during a translation by 0.1% of the diameter.

FIG. 4 shows a further embodiment 148 of a holding device in a sectional view, which can be used instead of the holding device 48 in the measurement apparatus 10 according to FIG. 1. The holding device 148 is configured to shift the reference element 32 in two translational degrees of freedom aligned transversely to the propagation direction of the reference wave 30r emitted by the reference element 32, i.e., in the x- and y-directions of the coordinate system of the drawing. This enables a so-called “shift-shift calibration.”

For this purpose, the holding device 148 comprises two y-actuators 60, with which the reference element 32 can be shifted in the y-direction, as indicated by the double-headed arrows 50. Furthermore, the holding device comprises two x-actuators 62, which are configured to shift the entire arrangement of the y-actuators 60 and the reference element 32 in the x-direction, as indicated by the double-headed arrows 64.

The adjustability of both the x-position and the y-position of the reference element 32 with the y-actuators 60 of the holding device 148 is in each case at least 0.1%, preferably at least 0.5% or even more preferably at least 1% of the diameter d of the reflection surface 33 (see shift of the point P in the x- or y-direction by Δ₁ or Δ₂— the shifted point P is denoted by P′₁ or P′₂, respectively). According to a further embodiment, the holding device 48 can be combined with the holding device 148 such that the resulting holding device can shift the reference element 32 in the x- and y-directions and also rotate it with respect to the axis of rotation 54.

FIG. 2 illustrates a further embodiment of a measurement apparatus 10 for interferometrically determining the shape of an optical surface 12 of a test object 14. The measurement apparatus 10 according to FIG. 2 differs from the measurement apparatus 10 according to FIG. 1 in that, instead of the reference element 32 designed as a reflective optical element, a reference element 232 in the form of a Fizeau element is provided. The Fizeau element serves, instead of the diffractive optical element 26 according to FIG. 1, to produce the reference wave 30 from the measurement radiation.

A collimator 226-1 and possibly a diffractive optical element 226-2 serve as test optical unit for producing the test wave 28 in the measurement apparatus 10 according to FIG. 2. The collimator 226-1 alone can be used when the target shape of the surface 12 of the test object deviates only slightly from a planar shape or a spherical shape. In the event of a greater deviation, for example when the target shape is configured as a free-form surface, the diffractive optical element 226-2 is used in addition to or as an alternative to the collimator 226-1 in the test optical unit.

The reference element 232 configured as a Fizeau element is arranged in the beam path of the incoming measurement radiation 18 downstream of the collimator 226-1 and upstream of the diffractive optical element 226-2 that may be present and has a Fizeau surface 233, on which part of the incoming measurement radiation 18 is reflected as a returning reference wave 30r. The measurement apparatus 10 according to FIG. 2 is thus configured as a Fizeau interferometer.

The reference element 232 is attached to the holding device 48 already described with reference to FIGS. 1 and 3. Alternatively, the holding device 148 described with reference to FIG. 4 or a combination of the holding devices 48 and 148 according to FIGS. 3 and 4 can also be used. The reference element 232 can thus be arranged at different calibration positions, which differ in a movement of the reference element 232 in at least one rigid body degree of freedom, in particular in two or three rigid body degrees of freedom.

The mode of operation of the measurement apparatus 10 according to FIG. 2 behaves analogously to the above-described mode of operation of the measurement arrangement 10 according to FIG. 1, i.e., one or more interferograms produced by superimposition of the returning reference wave 30r with the returning test wave 28r on the detector 44 are evaluated, taking into account a calibration deviation of the reference element 232, to determine the actual shape of the optical surface of the test object. The calibration deviation relates to deviations of the actual shape of the Fizeau surface 233 from a target shape, in particular a planar shape. During the calibration, as explained above with reference to the reference element 32 according to FIG. 1, interferograms produced by superimposition of the returning test wave 28r with the returning reference wave 30r at a plurality of calibration positions of the reference element 232 are evaluated.

A further embodiment of the interferometric measurement apparatus 10 is illustrated in FIG. 5. This further embodiment differs from the measurement apparatus 10 according to FIG. 1 only in the configuration of the diffractive optical element 26 for producing the reference wave 30 with a spherical rather than a plane wavefront, the configuration of the reference element 32 with a reflection surface 33 adapted to the spherical wavefront of the reference wave 30, and the configuration of the holding device for the reference element 32. The holding device is denoted by the reference numeral 248 in the embodiment according to FIG. 5.

The holding device 248 is configured to move the reference element 32 in two rotational degrees of freedom. The first rotational degree of freedom here relates to a rotational movement 266 about a first axis of rotation 254, which passes through the center point 270 of the spherical segment formed by the reflection surface 33 or the imaginary origin of the spherical reference wave 30. In the embodiment illustrated in FIG. 5, the first axis of rotation 254 is oriented perpendicularly to the plane of the drawing, i.e., in the x-direction. The second rotational degree of freedom relates to a rotational movement 268 about a second axis of rotation 256, which likewise runs through the center point 270 and is oriented perpendicularly to the first axis of rotation 254, in the illustration according to FIG. 1 in the y-direction. Both axes of rotation 254 and 256 are oriented perpendicularly to the propagation direction of the reference wave 30.

The holding device 248 comprises a spherical guide surface 258 for guiding the reference element 32 during the execution of the rotational movements 266 and 268. The spherical guide surface 258 runs along a spherical section 260 with the point 270 as the center of curvature. The holding device 248 comprises an actuator 262 integrated into the module with the guide surface 258 for executing the rotational movements 266 and 268 with respect to the axes of rotation 254 and 256, respectively. In the embodiment shown, the actuator 262 pulls a pin-like pulling element 266 attached to the reference element 32 along the spherical section 260. The actuation of the reference element 32 can also be achieved with a differently configured actuator.

The mode of operation of the measurement apparatus 10 according to FIG. 5 behaves analogously to the above-described mode of operation of the measurement arrangement 10 according to FIG. 1, i.e., one or more interferograms produced by superimposition of the returning reference wave 30r with the returning test wave 28r on the detector 44 are evaluated, taking into account a calibration deviation of the reference element 32, to determine the actual shape of the optical surface of the test object.

The calibration deviation relates to deviations of the actual shape of the reflection surface 33 from the spherical target shape. During the calibration, interferograms produced by superimposing the returning test wave 28r with the returning reference wave 30r at a plurality of calibration positions of the reference element 232 are evaluated, wherein the different calibration positions are set by executing a rotational movement about the axis of rotation 254 or the axis of rotation 256 or by executing respective rotational movements about both axes of rotation 254 and 256. The rotational movement about at least one of the axes of rotation 254 and 256 takes place in such a way that a peripheral point of the reflection surface 33 of the reference element 32 is shifted by at least 0.1% of the diameter d of the reflection surface 33. Furthermore, a rotation about an axis of rotation oriented in the irradiation direction of the reference wave 30 (similar to the axis of rotation 54 according to FIG. 1) can take place.

According to further embodiments which are not illustrated, the reference element 32 can also have other types of shapes with translational and/or rotational symmetry in addition to the planar and spherical shapes described above. Here, for example, the shape of a cylinder, a hyperboloid or a rotationally symmetrical asphere is feasible.

The above description of exemplary embodiments, embodiments or embodiment variants should be understood to be by way of example. The disclosure effected thereby firstly enables the person skilled in the art to understand the present invention and the advantages associated therewith, and secondly encompasses alterations and modifications of the described structures and methods that are also apparent to the person skilled in the art. Therefore, all such alterations and modifications, insofar as they fall within the scope of the invention in accordance with the definition in the accompanying claims, and equivalents are intended to be covered by the protection of the claims.

### LIST OF REFERENCE SIGNS

10 Measurement apparatus
12 Optical surface
14 Test object
16 Radiation source
18 Measurement radiation
20 Waveguide
22 Radiation-generating module
24 Beam splitter
26 Diffractive optical element
28 Test wave
28r Returning test wave
30 Reference wave
30r Returning reference wave
32 Reference element
33 Reflection surface
34 Diffraction structures
36 Capture device
38 Observation unit
40 Stop
42 Eyepiece
44 Detector
46 Evaluation device
48 Holding device
50 Translational degree of freedom
52 Rotational degree of freedom
54 Axis of rotation
58 Inner holding ring
58 Outer holding ring
60 y-actuator
62 x-actuator
64 Further translational degree of freedom
148 Holding device
232 Reference element
233 Fizeau surface
226-1 Collimator
226-2 Diffractive optical element
248 Holding device
254 First axis of rotation
256 Second axis of rotation
258 Spherical guide surface
260 Sphere section
262 Actuator
264 Pulling element
266 Rotational movement
268 Rotational movement
270 Center of the reflection surface

What is claimed is:

1. A measurement apparatus for interferometric shape measurement of a surface of a test object, comprising:
a test optical unit configured to produce from measurement radiation a test wave for irradiating the surface of the test object,
a reference element with an optically effective surface arranged to interact with a reference wave that is likewise produced from the measurement radiation and that serves to produce an interferogram by superimposition of the reference wave with the test wave after the test wave has interacted with the surface of the test object, and
a holding device arranged to hold the reference element and configured to move the reference element in relation to the reference wave in at least two rigid body degrees of freedom such that a peripheral point of the optically effective surface of the reference element is shifted by at least 0.1% of a diameter of the optically effective surface,
wherein the at least two rigid body degrees of freedom comprise a translational degree of freedom, which is directed transversely to a propagation direction of the reference wave emitted by the reference element, and a rotational degree of freedom, which has an axis of rotation aligned substantially parallel to the propagation direction of the reference wave emitted by the reference element.

2. The measurement apparatus as claimed in claim 1,
wherein the holding device is configured to move the reference element in the at least two rigid body degrees of freedom such that in each case the peripheral point of the optically effective surface of the reference element is shifted by at least 0.1% of the diameter of the optically effective surface.

3. The measurement apparatus as claimed in claim 1,
wherein the rigid body degrees of freedom, with respect to which the reference element is movable, further comprise a further translational degree of freedom.

4. The measurement apparatus as claimed in claim 1,
wherein the rigid body degrees of freedom further comprise at least one rotational degree of freedom which has an axis of rotation aligned transversely to the propagation direction of the reference wave emitted by the reference element.

5. The measurement apparatus as claimed in claim 1,
wherein the rigid body degrees of freedom further comprise at least a second rotational degree of freedom.

6. The measurement apparatus as claimed in claim 1,
wherein the holding device comprises a plurality of actuators for moving the reference element in the at least two rigid body degrees of freedom.

7. The measurement apparatus as claimed in claim 1,
wherein the reference element is a Fizeau element provided in a Fizeau interferometer comprised in the measurement apparatus.

8. The measurement apparatus as claimed in claim 1,
wherein the test optical unit comprises a diffractive optical element configured to split the incoming measurement radiation into the test wave in a beam path of the test wave and the reference wave in a beam path of the reference wave, and the reference element is arranged in the beam path of the reference wave.

9. The measurement apparatus as claimed in claim 8,
wherein the reference element is a mirror.

10. The measurement apparatus as claimed in claim 1,
wherein the test object comprises a microlithographic optical element and wherein the measurement apparatus is configured for the interferometric shape measurement of the surface of the microlithographic optical element.

11. A method for calibrating a measurement apparatus for interferometric shape measurement of a surface of a test object, which is configured to produce an interferogram by superimposition of a test wave after the test wave has interacted with the surface of the test object with a reference wave after the reference wave has interacted with a reference element, comprising:
arranging the reference element at different calibration positions with respect to the reference wave, which differ by a movement in at least two rigid body degrees of freedom,
recording interferograms produced at the different calibration positions, and
determining a calibration deviation based on a deviation of an optical effect of the reference element on a wavefront of the reference wave from a predetermined effect by evaluating the recorded interferograms,
wherein the at least two rigid body degrees of freedom comprise a translational degree of freedom, which is directed transversely to a propagation direction of the reference wave emitted by the reference element, and a rotational degree of freedom, which has an axis of rotation aligned substantially parallel to the propagation direction of the reference wave emitted by the reference element.

12. The method as claimed in claim 11,
wherein the test object is a microlithographic optical element.

13. A method for interferometric shape measurement of a surface of a test object, comprising:
determining a calibration deviation of the measurement apparatus with the method as claimed in claim 11,
recording a measurement interferogram with the measurement apparatus by superimposing the test wave after the test wave has interacted with the surface of the test object with the reference wave after the reference wave has interacted with the reference element in a measurement position, and
determining a shape of the surface of the test object by evaluating the measurement interferogram, taking into account the calibration deviation.
